(19) United States
(12) Patent Application Publication
(10) Pub. No.: US 2016/0259925 A1
(43) Pub. Date: Sep. 8, 2016

(54) TERMINAL UNLOCKING METHOD AND TERMINAL

(71) Applicant: GIONEE COMMUNICATION EQUIPMENT CO.,LTD. SHENZHEN, Shenzhen (CN)

(72) Inventor: Weibing LU, Shenzhen (CN)

(73) Assignee: GIONEE COMMUNICATION EQUIPMENT CO.,LTD. SHENZHEN, Shenzhen (CN)

(21) Appl. No.: 15/156,588

(22) Filed: May 17, 2016

Related U.S. Application Data
(63) Continuation of application No. PCT/CN2015/080159, filed on May 29, 2015.

(30) Foreign Application Priority Data
Oct. 31, 2014 (CN) 201410606501.4
Oct. 31, 2014 (CN) 201410606507.1

(51) Int. Cl. G06F 21/31; H04W 12/06

(52) U.S. Cl. CPC G06F 21/31; H04W 12/06

(57) ABSTRACT

The present invention provides a method for unlocking a terminal and a terminal. Wherein, the method includes displaying a set of contact identifiers on a terminal unlock interface, obtaining an unlock command input by a user performing an operation on a target contact identifier in the set of the contact identifiers, determining whether or not the target contact identifier is the preset contact identifier for unlock, and unlocking the terminal if yes. By means of the present invention, the protection for private data of the terminal brought by locking the terminal is enhanced, and the security and safety brought by locking the terminal is enhanced.

### CROSS REFERENCE TO RELATED APPLICATIONS

This application is a continuing application of PCT Patent Application No. PCT/CN2015/080159, entitled “TERMINAL UNLOCKING METHOD AND TERMINAL”, filed on May 29, 2015, which claims priority to Chinese Patent Application No. 2014106006507.1, entitled “METHOD FOR UNLOCKING A TERMINAL” and filed on Oct. 31, 2014, and Chinese Patent Application No. 201410606501.4, entitled “TERMINAL” and filed on Oct. 31, 2014, which are hereby incorporated in their entireties by reference.

### FIELD OF THE TECHNICAL

The present disclosure relates to information security technology field, and more particularly to a method for unlocking a terminal and a terminal.

### BACKGROUND

With quick development of communication technology, smart phones become more and more popular in daily life and functions become more and more powerful. People can use smart phones to do business, keep in touch with relatives and friends, share personal life, and so on, thus smart phones have more and more personal private data therein, and users gradually pay more attention to protection of privacy and fault operation. To protect personal privacy and avoid fault operation, smart phones usually have a lock function, that is, when a mobile phone is in a standby state, the mobile phone is in a lock state. When a user wants to use the mobile phone, firstly the user needs to perform a right unlock operation, and after that the user can normally use the mobile phone. In the existing technology, methods for unlocking a mobile phone which are commonly used include unlocking by long press of a specific button, unlocking by sliding, unlocking by pressing two or more buttons, unlocking by a password, unlocking by a Sudoku, and so on. Wherein, unlocking by long press of a specific button and unlocking by sliding are simple but do not have security function. Unlocking by pressing two or more buttons are generally applied to old functional mobile phones. For smart phones which have less physical buttons, unlocking by pressing two or more buttons brings lower safety. For unlocking by a password and unlocking by a Sudoku, generally the unlock action is a simple action, such as clicking, sliding, or other simple action. After setting, the unlock action does not change, and these around the user can remember the unlock action after seeing the execution of the unlock action. Especially for unlocking by a Sudoku, a trace may be left on the screen of the mobile phone after sliding, and others can know user's unlock trace according to the trace left on the screen, and safety is limited.

### SUMMARY

The embodiments of the present invention provides a method for unlocking a terminal and a terminal. The present invention can display a set of contact identifiers on a terminal unlock interface, obtain an unlock command input by a user performing an operation on a target contact identifier in the set of the contact identifiers, and unlock the terminal when it is determined that the target contact identifier is the contact identifier for unlock, thus the protection for private data of the terminal brought by locking the terminal is enhanced, and the security and safety brought by locking the terminal is enhanced.

In one aspect, the embodiments of the present invention provides a method for unlocking a terminal, the method includes the following steps.

Displaying a set of contact identifiers on a terminal unlock interface, wherein the set of the contact identifiers comprise a preset contact identifier for unlock and preset contact identifiers for interference.

Obtaining an unlock command input by a user performing an operation on a target contact identifier in the set of the contact identifiers.

Determining whether or not the target contact identifier is the preset contact identifier for unlock.

Unlocking the terminal if yes.

In another aspect, the present invention provides a terminal. The terminal includes the following units.

A displaying unit is configured to display a set of contact identifiers on a terminal unlock interface, wherein the set of the contact identifiers comprise a preset contact identifier for unlock and preset contact identifiers for interference.

An obtaining unit is configured to obtain an unlock command input by a user performing an operation on a target contact identifier in the set of the contact identifiers.

A determining unit is configured to determine whether or not the target contact identifier is the preset contact identifier for unlock.

An unlocking unit configured to unlock the terminal when it is determined that the target contact identifier is the preset contact identifier for unlock.

The embodiments of the present invention can display a set of contact identifiers on a terminal unlock interface, obtain an unlock command input by a user performing an operation on a target contact identifier in the set of the contact identifiers, and unlock the terminal when it is determined that the target contact identifier is the contact identifier for unlock, thus the protection for private data of the terminal brought by locking the terminal is enhanced, and the security and safety brought by locking the terminal is enhanced.

### BRIEF DESCRIPTION OF THE DRAWINGS

To better illustrate the technical solution of embodiments of the present invention, the following descriptions will briefly illustrate the accompanying drawings described in the embodiments. Obviously, the following described accompanying drawings are some embodiments of the present invention. Those skilled in the art can obtain other accompanying drawings according to the described accompanying drawings without creative work.

FIG. 1 is a flow chart of a method for unlocking a terminal in accordance with an exemplary embodiment of the present invention.

FIG. 2 is a flow chart of another method for unlocking a terminal in accordance with an exemplary embodiment of the present invention.

FIG. 3a is a first schematic view showing contact identifiers displayed by a displaying unit in accordance with an exemplary embodiment of the present invention.

FIG. 3b is a second schematic view showing contact identifiers displayed by a displaying unit in accordance with an exemplary embodiment of the present invention.

FIG. 4 is a schematic view of a structure of a terminal in accordance with an exemplary embodiment of the present invention.

FIG. 5 is a schematic view of another structure of a terminal in accordance with an exemplary embodiment of the present invention.

### DETAILED DESCRIPTION OF ILLUSTRATED EMBODIMENTS

The technical solution of embodiments of the present invention will be described clearly and completely in combination with the accompanying drawings of the embodiments of the present invention. Obviously, the described embodiments are a part of embodiments of the present invention, and not all of the embodiments. According to the embodiments of the present invention, other embodiments obtained by those skilled in the art without creative work all fall within the protection scope of the present invention.

In detail, a terminal described in an exemplary embodiment of the present invention may be a mobile phone, a tablet computer, a laptop computer, an on-board equipment, a PDA, a wearable smart device, or other.

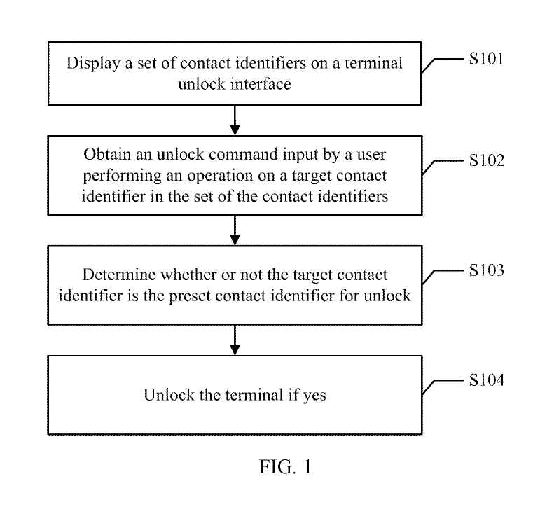

The following will specifically describe a method for unlocking a terminal and the terminal in accordance with an exemplary embodiment of the present invention in combination with FIGS. 1-5.

FIG. 1 is a flow chart of a method for unlocking a terminal in accordance with an exemplary embodiment of the present invention. The method for unlocking the terminal shown in this figure may includes the following steps.

In step S101, displaying a set of contact identifiers on a terminal unlock interface.

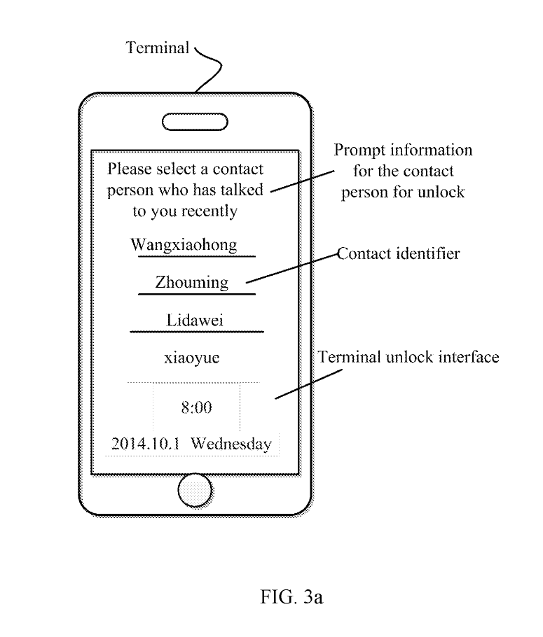

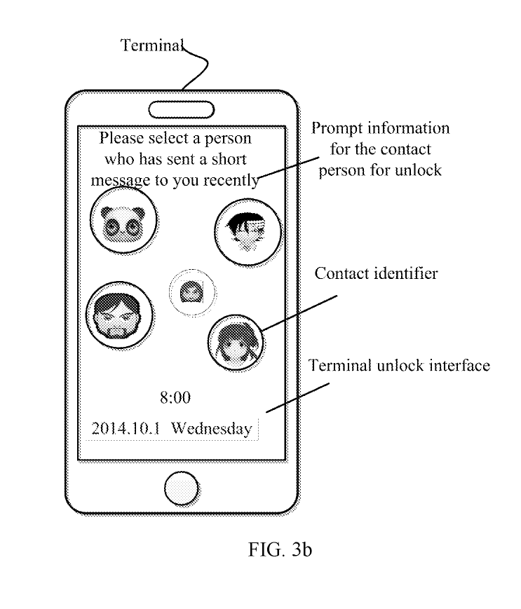

Specifically, the set of the contact identifiers include a preset contact identifier for unlock and preset contact identifiers for interference. When the terminal is in an unlock state, the terminal unlock interface is displayed after the terminal is started in response to user's operation. The terminal displays the set of contact identifiers on the terminal unlock interface. The terminal unlock interface is displayed on a display screen of the terminal. The display screen may be a touchscreen of the terminal on which the user can perform a touch operation. The display screen may be also a display screen only having the display function. If the user of the terminal wants to know more application information of the terminal or wants to use more application functions of the terminal, such as wants to make a call, send an email, browse a webpage, or do other things, it needs the user to perform an operation to display the terminal unlock interface, and after the terminal is unlocked through the terminal unlock interface, a terminal operation interface is display for the user to make a call, send an email, browse a webpage, or do other things. In this embodiment, when the terminal detects that the contact identifier for unlock is selected by the user, rather than one contact identifier for interference is selected by the user, the terminal executes an unlock operation. The contact persons are selected from contact lists of instant communication software and social software, such as QQ, a mobile phone, Fetion, Wechat, and so on. The contact lists include but not limited to an address book, an email contact list, a Wechat contact list, a QQ contact list, a Fetion contact list, a Renren friend list, and so on. The contact identifiers include but not limited to contact names, contact nicknames, contact head portraits, and so on. The set of the contact identifiers include a number of contact identifiers, and include one preset contact identifier for unlock and at least one preset contact identifier for interference. Optionally, as shown in FIG. 3a which is a first schematic view showing the contact identifiers displayed by the displaying unit in accordance with an exemplary embodiment of the present invention and FIG. 3B which is a second schematic view showing the contact identifiers displayed by the displaying unit in accordance with an exemplary embodiment of the present invention, on the terminal unlock interface, the contact identifiers in the set of the contact identifiers are displayed on the terminal unlock interface in a bubble floating manner or in an icon arranging manner.

In step S302, obtaining an unlock command input by the user performing an operation on a target contact identifier in the set of the contact identifiers.

Specifically, after the terminal unlock interface is displayed, the user can perform an unlock operation on the set of the contact identifiers displayed on the terminal unlock interface. The unlock operation includes a step of selecting a target contact identifier, and a step of inputting the unlock command by performing an operation on the target contact identifier. The target contact identifier is one contact identifier selected from the set of the contact identifiers. The unlock command may be input by long press of the target contact identifier, clicking the target contact identifier twice, clicking the target contact identifier once, dragging the target contact identifier along a preset track, long press of a confirm button for selecting the target contact identifier, clicking the confirm button twice for selecting the target contact identifier, clicking the confirm button once for selecting the target contact identifier, or other. For example, during the unlock process, firstly, one contact identifier is selected from the terminal unlock interface by the user as the target contact identifier. If the terminal display screen is a touchscreen, the user can click the target contact identifier twice through the touchscreen to finish inputting an unlock command by the user performing an operation on the target contact identifier in the set of the contact identifiers. When the terminal detects that the user clicks the target contact identifier in the set of the contact identifiers, the terminal obtains the target contact identifier and the unlock command.

In step S103, determining whether or not the target contact identifier is the preset contact identifier for unlock.

Specifically, to lock the terminal, the terminal presets a contact person for unlock and contact persons for interference, and then obtains the contact identifiers of the contact person for unlock and the contact persons for interference to establish the set of the contact identifiers, and accordingly displays the set of the contact identifiers on the terminal unlock interface. The contact identifier selected by the user during the unlock process may be the contact identifier for unlock, or may be the contact identifier for interference. When the selected target contact identifier is the contact identifier for unlock, step S104 is executed, and the terminal is unlocked. In step S102 when the unlock command generated by the user performing an operation on the target contact identifier in the set of the contact identifiers is obtained, the target contact identifier is obtained, and in this step whether or not the target contact identifier is the preset contact identifier for unlock is determined.

In step S104, unlocking the terminal if yes.

Specifically, when in step S103 the target contact identifier is the contact identifier for unlock rather than the contact identifier for interference, the terminal is unlocked, and accordingly the terminal operation interface is displayed for the user to know more application information of the terminal and use more application functions of the terminal, such as make a call, browse a webpage, share information, and so on.

As used for an optional embodiment, in the method shown in FIG. 1, before executing step S101 by the terminal, the following steps are executed.

In step 11, determining contact persons corresponding to communication events which have already been processed within a preset time period as the set of contact persons for unlock.

In detail, the communication events include instant communication events and social software communication events, such as emails, short messages, calls, chat, messages, and so on. The communication events which have already been processed include various communication events which at least have been looked up by the user to have an impression, such as read emails, read short messages, received calls or dialed calls, responses for chat, and so on. It should be illustrated that the preset time period can be defaulted to 24 hours, 12 hours, 6 hours, or other reasonable time period. For a user who is busy with communication events, the user may be easily confused by and may easily forget the communication events happened 24 hours ago, thus it is not suitable to set the preset time period to be too long. For a user who may not be busy with communication events, the terminal may not process any communication event within 6 hours, thus it is not suitable to set the preset time period to be too short. The terminal can provide the user with a function for setting the preset time period manually, thus the user can select the setting option to set the preset time period according to user's need. When the terminal enters the lock state, the terminal firstly queries various instant communication events and social software communication events, and then selects the communication events which have already been processed within the preset time period, and finally determines the contact persons corresponding to the communication events which have already been processed within the preset time period as the set of the contact persons for unlock. For example, if the preset time period is 24 hours, and the mobile terminal enters the lock state at 12:00 on October 9th, at this point, the mobile terminal executes a query operation and determines that cell phone call records include four call records which include a received call called by 150****3456 at 11:00 on October 9th, a received call called by 150****3457 at 11:59 on October 8th, a dialed called received by 150****3458 at 15:00 on October 8th, and a missed call called by 150****3459 at 10:00 on October 9th. The inbox of QQ mailbox of the mobile phone includes two email records which include a read email received from xiaoming@163.com at 9:00 on October 9th, and an unread email received from xiaohong@qq.com at 11:00 on October 9th. Wherein, the received call called by 150****3457 at 11:59 on October 8th is the communication event which have already been processed but the process time of which is not within the preset time period, the missed call called by 150****3459 at 10:00 on October 9th and the unread email received from xiaohong@qq.com at 11:00 on October 9th are the communication events which have occurred within the preset time period but are still not processed, while the received call called by 150****3456 at 11:00 on October 9th and the read email received from xiaoming@163.com at 11:00 on October 9th are the communication events which have already been processed within 24 hours, thus the mobile terminal selects these three communication events which have already been processed within the preset time period, and determines the contact persons 150****3456, 150****3458, and xiaoming@163.com respectively corresponding to these three communication events which have already been processed within the preset time period as the set of the contact persons for unlock.

Optionally, the terminal may provide the user with a function of setting the set of the contact persons for unlock manually, thus the terminal can determine at least one contact person selected from a contact list by the user as the set of the contact persons for unlock. For example, if there is no processed communication event within the preset time period, when the terminal is about to enter the lock state, the terminal outputs a text message “please select contact persons for unlock” and displays the text message on the display screen of the terminal. If the display screen is a touchscreen, when the user clicks the text message, a terminal contact list interface is displayed, and the user can select at least one contact person from a contact list. The terminal determines the at least one contact person selected from the contact list by the user as the set of the contact persons for unlock.

In step 12, selecting one contact person from the set of the contact persons for unlock as the contact person for unlock.

Specifically, the terminal may select one contact person from the set of the contact persons for unlock as the contact person for unlock according to the happening time of communication events. Generally, the user has a deep impression on the communication event the happening time of which is closest to the time of locking the terminal, thus preferably the contact person corresponding to the processed communication event the happening time of which is closet to the time of locking the terminal may be determined as the contact person for unlock. For example, in the examples of step 11, the terminal queries the set of the contact persons which include 150****3456, 150****3458, and xiaoming@163.com, and determines that the communication event corresponding to the contact person 150****3456 is the received call happened at 11:00 on October 9th, and the communication event corresponding to the contact person 150****3456 is the processed communication event the happening time of which is closet to the time of locking the terminal, and accordingly 150****3456 is selected as the contact person for unlock. Optionally, if there is no processed communication event within the preset time period, in step 11 after the user selects at least one contact person from a contact list as the set of the contact person for unlock, in this step the terminal can select one contact person from the set of the contact persons for unlock as the contact person for unlock. Optionally, one contact person in the set of the contact persons for unlock is selected as the contact person for unlock randomly.

In step 13, selecting at least one contact person who is in a contact list of the user and outside of the set of the contact persons for unlock as the contact person for interference.

Specifically, after obtaining various contact lists of the user in the terminal, the contact persons in the set of the contact persons for unlock determined in step 11 are excluded, and then at least one contact person may be selected from the contact persons who are in the contact lists of the user and outside of the set of the contact persons for unlock as the contact person for interference. Furthermore, the terminal may select the contact persons for interference from the contact list the type of the communication events corresponding to the contact persons in which is the same as the type of the communication event corresponding to the contact person for unlock according to the type of the communication event corresponding to the contact person for unlock. For example, if the communication event corresponding to the contact person for unlock is a voice call, the mobile terminal selects the contact persons for interference from the address book of the mobile terminal. If the communication event corresponding to the contact for unlock is a QQ mail, the mobile terminal selects the contact persons for interference from the contact list of QQ mailbox.

In step 14, obtaining the contact identifiers of the selected contact person for unlock and the contact persons for interference to establish the set of the contact person identifiers.

Specifically, after executing steps 11-13, the terminal can determine the contact person for unlock and the contact persons for interference, and then obtain the contact identifiers of the contact person for unlock and the contact persons for interference to establish the set of the contact person identifiers. The contact identifiers include but not limited to contact names, contact nicknames, and contact head portraits.

Through steps 11-14, the terminal can obtain the set of the contact person identifiers, and display the set of the contact person identifiers on the terminal unlock interface to wait for an unlock operation performed by the user on the set of the contact person identifiers.

In the embodiments of the present invention, by displaying the set of the contact person identifiers on the terminal unlock interface, by obtaining the unlock command input by the user performing an operation on the target contact person identifier in the set of the contact person identifiers, and by unlocking the terminal when it is determined that the target contact identifier is the contact identifier for unlock, the protection for private data of the terminal brought by locking the terminal is enhanced, and the security and safety brought by locking the terminal is enhanced.

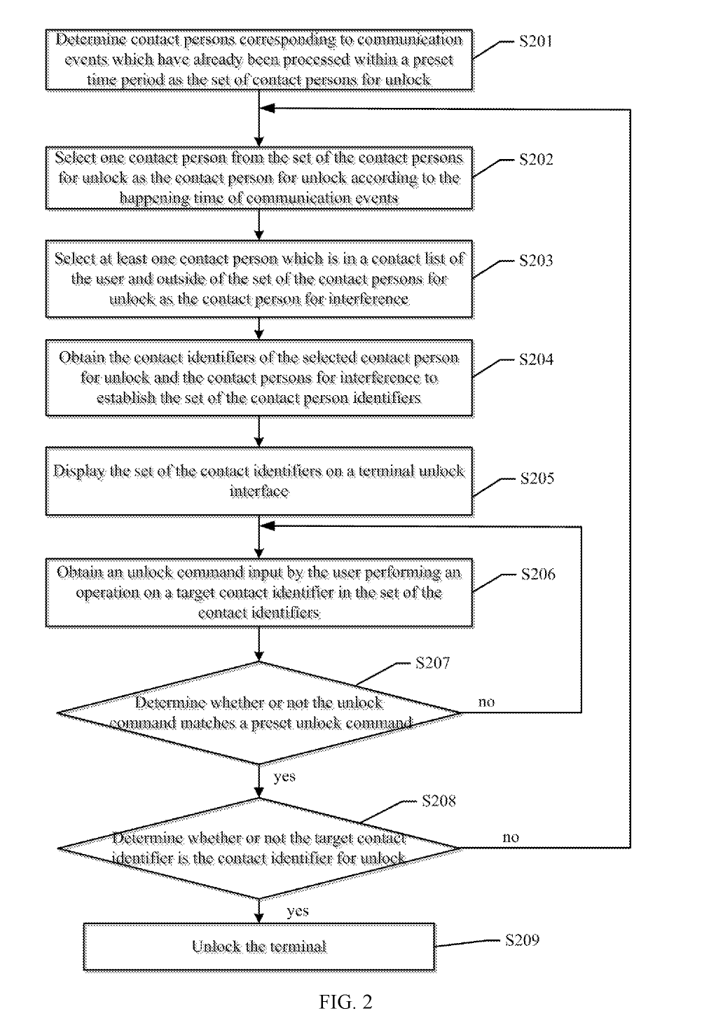

FIG. 2 is a flow chart of another method for unlocking a terminal in accordance with an exemplary embodiment of the present invention. The method for unlocking the terminal shown in this figure may includes the following steps.

In step S201, determining contact persons corresponding to communication events which have already been processed within a preset time period as the set of contact persons for unlock.

In this step step 11 in the embodiments of FIG. 1 can be referred and will not be repeated herein.

In step S202, selecting one contact person from the set of the contact persons for unlock as the contact person for unlock according to the happening time of communication events.

Specifically, generally, the user has a deep impression on the communication event the happening time of which is closest to the time of locking the terminal, thus preferably the contact person corresponding to the processed communication event the happening time of which is closet to the time of locking the terminal may be determined as the contact person for unlock. For example, in the examples of step 11 illustrated in the embodiments of FIG. 1, the terminal queries the set of the contact persons which include 150****3456, 150****3458, and xiaoming@163.com, and determines that the communication event corresponding to the contact person 150****3456 is the received call happened at 11:00 on October 9th, and the communication event corresponding to the contact person 150****3456 is the processed communication event the happening time of which is closet to the time of locking the terminal, and accordingly 150****3456 is selected as the contact person for unlock. Furthermore, in this step the type information of the processed communication event corresponding to the contact person for unlock is obtained and in step S205 the obtained type information is displayed on the terminal unlock interface to prompt the user to select the contact person for unlock. The processed communication event may be a call, a short message, an email, a Wechat information, a video, or other instant communication event or social software communication event. For example, in the above embodiments, the communication event corresponding to the contact person for unlock is the received call happened at 11:00 on October 9th, and the processed communication event corresponding to the contact person for unlock is a call. Optionally, if there is no processed communication event within the preset time period, in step S201 after determining at least one contact person selected from a contact list by the user as the set of the contact persons, the terminal can determine whether or not there are processed communication events corresponding to the contact persons for unlock in the set of the contact persons for unlock which is set manually. If there are processed communication events, in this step the terminal can select on contact person from the set of the contact persons as the contact person for unlock according to the happening time of communication events. If there is no communication event, the terminal can determine one contact person selected from the set of the contact persons for unlock manually as the contact person for unlock. Optionally, the terminal can randomly select one contact person from the set of the contact persons for unlock as the contact person for unlock.

In step S203, selecting at least one contact person which is in a contact list of the user and outside of the set of the contact persons for unlock as the contact person for interference.

Specifically, the contact lists include but not limited to various instant communication contact lists and social software contact lists, such as an address book, an email contact list, a Wechat contact list, a QQ contact list, a Fetion contact list, a Renren friend list, and so on. After obtaining various contact lists of the user in the terminal, the contact persons in the set of the contact persons for unlock determined in step S201 are excluded, and then at least one contact person may be selected from the contact persons who are in the contact lists of the user and outside of the set of the contact persons for unlock as the contact person for interference. Furthermore, the terminal may select the contact persons for interference from the contact list the type of the communication events corresponding to the contact persons in which is the same as the type of the communication event corresponding to the contact person for unlock according to the type of the communication event corresponding to the contact person for unlock. For example, if the communication event corresponding to the contact person for unlock is a voice call, the mobile terminal selects the contact persons for interference from the address book of the mobile terminal. If the communication event corresponding to the contact for unlock is a QQ mail, the mobile terminal selects the contact persons for interference from the contact list of QQ mailbox.

In step S204, obtaining the contact identifiers of the selected contact person for unlock and the contact persons for interference to establish the set of the contact person identifiers.

Specifically, after executing step S201 to S203, the terminal can determine the contact person for unlock and the contact persons for interference, and then obtain the contact identifiers of the contact person for unlock and the contact persons for interference to establish the set of the contact person identifiers. The contact identifiers may include but not limited to one of or a combination of contact names, contact nicknames, and contact head portraits.

In step S205, displaying the set of the contact identifiers on the terminal unlock interface.

From step S201 to step 204, it can be seen that the set of the contact identifiers include a preset contact identifier for unlock and preset contact identifiers for interference. When the terminal is in an unlock state, the terminal unlock interface is displayed after the terminal is started in response to user's operation. The terminal displays the set of contact identifiers on the terminal unlock interface. The terminal unlock interface is displayed on a display screen of the terminal. The display screen may be a touchscreen of the terminal on which the user can perform a touch operation. The display screen may be also a display screen only having the display function. If the user of the terminal wants to know more application information of the terminal or wants to use more application functions of the terminal, such as wants to make a call, send an email, browse a webpage, or do other things, it needs the user to perform an operation to display the terminal unlock interface, and after the terminal is unlocked through the terminal unlock interface, a terminal operation interface is display for the user to make a call, send an email, browse a webpage, or do other things. The contact identifiers in the set of the contact identifiers are displayed on the terminal unlock interface in a bubble floating manner or in an icon arranging manner. Optionally, prompt information for the contact person for unlock is displayed on the terminal unlock interface. The prompt information includes type information of the processed communication events corresponding to the contact person for unlock. The communication events include but not limited to various instant communication events and social software communication events such as calls, short message, emails, chats of Wechat, or videos. For example, if the communication event corresponding to the contact person 150****3456 is the received call received a 11:00 on October 9th, the terminal can set the prompt information for the contact person for unlock to be that of selecting the contact person who talks to you recently to unlock the terminal.

In step S206, obtaining an unlock command input by the user performing an operation on a target contact identifier in the set of the contact identifiers.

In this step step S102 in the embodiments of FIG. 1 can be referred and will not be repeated herein.

In step S207, determining whether or not the unlock command matches a preset unlock command.

Specifically, the unlock command may be input by long press of the target contact identifier, clicking the target contact identifier twice, clicking the target contact identifier once, dragging the target contact identifier along a preset track, long press of a confirm button for selecting the target contact identifier, clicking the confirm button twice for selecting the target contact identifier, clicking the confirm button once for selecting the target contact identifier, or other. When the terminal determines that the input command input by the user performing an operation on the target contact identifier in the set of the contact identifiers matches the preset unlock command, the procedure returns to step S208. If there is no match, the terminal keeps displaying the terminal unlock interface to obtain the unlock command input by the user performing an operation on the target contact identifier in the set of the contact identifiers. Optionally, if there is no match, the terminal displays an information for indicating that the input unlock command is fault on the terminal unlock interface. For example, if the command input by long press of the target contact identifier is the preset unlock command, when the unlock command obtained by the terminal is input by clicking the target contact identifier twice, the terminal displays a text message recording information of performing a long press on the contact person for unlock on the terminal unlock interface.

In step S208, determining whether or not the target contact identifier is the preset contact identifier for unlock.

Specifically, the contact identifier selected by the user during the unlock process may be the contact identifier for unlock, or may be the contact identifier for interference. When the selected target contact identifier is the contact identifier for unlock, step S209 is executed, and the terminal is unlocked. In step S206 when the unlock command input by the user performing an operation on the target contact identifier in the set of the contact identifiers is obtained, the target contact identifier is obtained, and in this step whether or not the target contact identifier is the preset contact identifier for unlock is determined. If yes, step S209 is executed. If not, the procedure returns to step S202, and steps S202-S208 are executed sequentially again. Another contact person in the set of the contact persons for unlock is selected as the contact person for unlock, and at least one other contact person who is in a contact list of the user and outside of the set of the contact persons for unlock is selected as the contact person for interference. Another set of the contact identifiers is established according to the obtained contact identifiers of the another contact person for unlock and the at least one other contact person for interference, and the another set of the contact identifiers is displayed on the terminal unlock interface. The terminal again obtains the unlock command input by the user performing an operation on a target contact identifier in the another set of the contact identifiers, and again determines whether or not the unlock command matches the preset unlock command, and again determines whether or not the target contact identifier is the contact identifier for unlock. Optionally, the times of determining whether or not the target contact identifier is the contact identifier for unlock is determined. If the times of determining that the target contact identifier is not the contact identifier for unlock reaches a preset value, the terminal enters the lock state, and later the user can perform an unlock operation, or the terminal will enter a password unlock interface to prompt the user to input a password to unlock the terminal.

In step S209, unlocking the terminal if yes.

Specifically, when in step S206 the target contact identifier is the preset contact identifier for unlock rather than the contact identifier for interference, and in step S207 the unlock command matches the preset unlock command, the terminal is unlocked, and the terminal operation interface is displayed to allow the user to know more application information of the terminal and use more application functions of the terminal, such as to make a call, browse a webpage, share information, and so on.

In the embodiments of the present invention, by presetting the contact person for unlock and the contact persons for interference in the terminal, by displaying the set of the contact identifiers including the contact identifiers of the contact person for unlock and the contact persons for interference on the terminal unlock interface, by obtaining the unlock command input by a user performing an operation on the target contact identifier in the set of the contact identifiers, and by unlocking the terminal when it is determined that the target contact identifier is the contact identifier for unlock and when it is determined that the input unlock command matches the preset unlock command, the protection for private data of the terminal brought by locking the terminal is enhanced, and the security and safety brought by locking the terminal is enhanced.

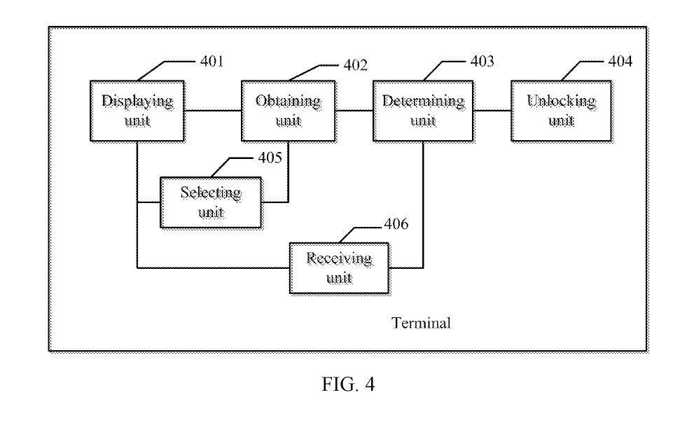

FIG. 4 is a schematic view of a structure of a terminal provided by an embodiment of the present invention. The terminal shown in this figure at least includes a displaying unit 401, an obtaining unit 402, a determining unit 403, and an unlocking unit 404.

The displaying unit 401 is configured to display a set of contact identifiers on a terminal unlock interface. The set of contact identifiers include a preset contact identifier for unlock and preset contact identifiers for interference.

Specifically, when the terminal is in an unlock state, the terminal unlock interface is displayed after the terminal is started in response to user's operation. The terminal displays the set of the contact identifiers on the terminal unlock interface. The terminal unlock interface is displayed on a display screen of the terminal. The display screen may be a touchscreen of the terminal on which the user can perform a touch operation. The display screen may be also a display screen only having the display function. If the user of the terminal wants to know more application information of the terminal or wants to use more application functions of the terminal, such as wants to make a call, send an email, browse a webpage, or do other things, it needs the user to perform an operation to display the terminal unlock interface, and after the terminal is unlocked through the terminal unlock interface, a terminal operation interface is display for the user to make a call, send an email, browse a webpage, or do other things. The contact persons are selected from contact lists of instant communication software and social software, such as QQ, a mobile phone, Fetion, Wechat, and so on. The contact lists include but not limited to an address book, an email contact list, a Wechat contact list, a QQ contact list, a Fetion contact list, a Renren friend list, and so on. The contact identifiers include but not limited to contact names, contact nicknames, contact head portraits, and so on. The set of the contact identifiers include a number of contact identifiers, and include one preset contact identifier for unlock and at least one preset contact identifier for interference. Optionally, as shown in FIG. 3a which is a first schematic view showing the contact identifiers displayed by the displaying unit in accordance with an exemplary embodiment of the present invention and FIG. 3B which is a second schematic view showing the contact identifiers displayed by the displaying unit in accordance with an exemplary embodiment of the present invention, on the terminal unlock interface, the contact identifiers in the set of the contact identifiers are displayed on the terminal unlock interface in a bubble floating manner or in an icon arranging manner.

An obtaining unit 402 is configured to obtain an unlock command input by the user performing an operation on a target contact identifier in the set of the contact identifiers.

Specifically, after the terminal unlock interface is displayed, the user can perform an unlock operation on the set of the contact identifiers displayed on the terminal unlock interface. The unlock operation includes a step of selecting the target contact identifier, and a step of inputting the unlock command by performing an operation on the target contact identifier. The target contact identifier is one contact identifier selected from the set of the contact identifiers. The unlock command may be input by long press of the target contact identifier, clicking the target contact identifier twice, clicking the target contact identifier once, dragging the target contact identifier along a preset track, long press of a confirm button for selecting the target contact identifier, clicking the confirm button twice for selecting the target contact identifier, clicking the confirm button once for selecting the target contact identifier, or other. For example, during the unlock process, firstly, one contact identifier is selected from the terminal unlock interface by the user as the target contact identifier. If the display screen of the terminal is a touchscreen, the user can click the target contact identifier twice through the touchscreen to finish inputting an unlock command by the user performing an operation on the target contact identifier in the set of the contact identifiers. When the terminal detects that the user clicks the target contact identifier in the set of the contact identifiers, the obtaining unit 402 obtains the target contact identifier and the unlock command.

The determining unit 403 is configured to determine whether or not the target contact identifier is the preset contact identifier for unlock.

Specifically, to lock the terminal, the terminal presets a contact person for unlock and contact persons for interference, and then obtains the contact identifiers of the contact person for unlock and the contact persons for interference to establish the set of the contact identifiers, and accordingly displays the set of the contact identifiers on the terminal unlock interface. The contact identifier selected by the user during the unlock process may be the contact identifier for unlock, or may be the contact identifier for interference. When the selected target contact identifier is the contact identifier for unlock, the terminal is unlocked. When the obtaining unit 402 obtains the unlock command input by the user performing an operation on the target contact identifier in the set of the contact identifiers, the obtaining unit 402 obtains the target contact identifier, and the determining unit 403 determines whether or not the target contact identifier is the preset contact identifier for unlock.

The unlocking unit 404 is configured to unlock the terminal when it is determined that the target contact identifier is the contact identifier for unlock.

Specifically, when the determining unit 403 determines that the target contact identifier is the contact identifier for unlock rather than the contact identifier for interference, the unlocking unit 404 unlocks the terminal, and accordingly the terminal operation interface is displayed to allow the user to know more application information of the terminal and use more application functions of the terminal, such as make a call, browse a webpage, share information, and so on.

As used for an optional embodiment, the obtaining unit 402 is further configured to determine contact persons corresponding to communication events which have already been processed within a preset time period as the set of contact persons for unlock.

In detail, the communication events include instant communication events and social software communication events, such as emails, short messages, calls, chat, messages, and so on. The communication events which have already been processed include various communications events which at least have been looked up by the user to have an impression, such as read emails, read short messages, received calls or dialed calls, responses for chat, and so on. It should be illustrated that the preset time period can be defaulted to 24 hours, 12 hours, 6 hours, or other reasonable time period. For a user who is busy with communication events, the user may be easily confused by and may easily forget the communication events happened 24 hours ago, thus it is not suitable to set the preset time period to be too long. For a user who may not be busy with communication events, the terminal may not process any communication event within 6 hours, thus it is not suitable to set the preset time period to be too short. The terminal can provide the user with a function for setting the preset time period manually, thus the user can select the setting option to set the preset time period according to user's need. When the terminal enters the lock state, the terminal firstly queries various instant communication events and social software communication events, and then selects the communication events which have already been processed within the preset time period, and finally determines the contact persons corresponding to the communication events which have already been processed within the preset time period as the set of the contact persons for unlock. For example, if the preset time period is 24 hours, and the mobile terminal enters the lock state at 12:00 on October 9th, at this point, the mobile terminal executes a query operation and determines that cell phone call records include four call records which include a received call called by 150****3456 at 11:00 on October 9th, a received call called by 150****3457 at 11:59 on October 8th, a dialed called received by 150****3458 at 15:00 on October 8th, and a missed call called by 150****3459 at 10:00 on October 9th. The inbox of QQ mailbox of the mobile terminal includes two email records which include a read email received from xiaoming@163.com at 9:00 on October 9th, and an unread email received from xiaohong@qq.com at 11:00 on October 9th. Wherein, the received call called by 150****3457 at 11:59 on October 8th is the communication event which have already been processed but the process time of which is not within the preset time period, the missed call called by 150****3459 at 10:00 on October 9th and the unread email received from xiaohong@qq.com at 11:00 on October 9th are the communication events which have occurred within the preset time period but are still not processed, while the received call called by 150****3456 at 11:00 on October 9th and the read email received from xiaoming@163.com at 11:00 on October 9th are the communication events which have already been processed within 24 hours, thus the mobile terminal selects these three communication events which have already been processed within the preset time period, and determines the contact persons 150****3456, 150****3458, and xiaoming@163.com respectively corresponding to these three communication events which have already been processed within the preset time period as the set of the contact persons for unlock. Optionally, the terminal may provide the user with a function of setting the set of the contact persons for unlock manually, and the obtaining unit 402 determines at least one contact person selected from a contact list by the user as the set of the contact persons for unlock. For example, if there is no processed communication event within the preset time period, when the terminal is about to enter the lock state, the terminal outputs a text message “please select contact persons for unlock” and displays the text message on the terminal display screen. If the display screen is a touchscreen, when the user clicks the text message, a terminal contact list interface is displayed, and the user can select at least one contact person from a contact list. The obtaining unit 402 determines the at least one contact person selected from the contact list by the user as the set of the contact persons for unlock.

Accordingly, the terminal further includes the following unit.

A selecting unit 405 is configured to select one contact person from the set of the contact persons for unlock as the contact person for unlock.

Specifically, the selecting unit 405 may select one contact person from the set of the contact persons for unlock as the contact person for unlock according to the happening time of communication events. Generally, the user has a deep impression on the communication event the happening time of which is closest to the time of locking the terminal, thus preferably the contact person corresponding to the processed communication event the happening time of which is closet to the time of locking the terminal may be determined as the contact person for unlock. For example, in the examples of step 11, the terminal queries the set of the contact persons which include 150****3456, 150****3458, and xiaoming@163.com, and determines that the communication event corresponding to the contact person 150****3456 is the received call happened at 11:00 on October 9th, and the communication event corresponding to the contact person 150****3456 is the processed communication event the happening time of which is closet to the time of locking the terminal, and accordingly 150****3456 is selected as the contact person for unlock. Optionally, if there is no processed communication event within the preset time period, after the obtaining unit 402 determines the at least one contact person selected from a contact list by the user as the set of the contact person for unlock, the selecting unit 405 can select one contact person from the set of the contact persons for unlock which is set manually as the contact person for unlock. Optionally, the selecting unit 405 can randomly select one contact person from the set of the contact persons for unlock as the contact person for unlock.

The selecting unit 405 is further configured to select at least one contact person who is in a contact list of the user and outside of the set of the contact persons for unlock as the contact person for interference.

Specifically, after the obtaining unit 402 obtains various contact lists of the user in the terminal, the obtaining unit 402 excludes the contact persons in the set of the contact persons for unlock, and then the selecting unit 405 may randomly select at least one contact person from the contact persons who are in the contact lists of the user and outside of the set of the contact persons for unlock as the contact person for interference. Furthermore, the selecting unit 405 may select the contact persons for interference from the contact list the type of the communication events corresponding to the contact persons in which is the same as the type of the communication event corresponding to the contact person for unlock according to the type of the communication event corresponding to the contact person for unlock. For example, if the communication event corresponding to the contact person for unlock is a voice call, the mobile terminal selects the contact persons for interference from the address book of the mobile terminal. If the communication event corresponding to the contact for unlock is a QQ mail, the mobile terminal selects the contact persons for interference from the contact list of QQ mailbox.

The obtaining unit 402 is further configured to obtain the contact identifiers of the selected contact person for unlock and the contact persons for interference to establish the set of the contact person identifiers.

Specifically, after the obtaining unit 402 and the selecting unit 405 execute steps 11-13 in the embodiments of FIG. 1, the terminal can determine the contact person for unlock and the contact persons for interference, and then the obtaining unit 402 obtains the contact identifiers of the contact person for unlock and the contact persons for interference to establish the set of the contact person identifiers. The contact identifiers include but not limited to contact names, contact nicknames, and contact head portraits.

In an optional embodiment, the determining unit 403 is further configured to determine whether or not the unlock command input by the user matches the preset unlock command, and the unlocking unit 404 is configured to determine whether or not to unlock the terminal according to the comparison between the unlock command input by the user and the preset unlock command.

Specifically, the unlock command may be input by long press of the target contact identifier, clicking the target contact identifier twice, clicking the target contact identifier once, dragging the target contact identifier along a preset track, long press of a confirm button for selecting the target contact identifier, clicking the confirm button twice for selecting the target contact identifier, clicking the confirm button once for selecting the target contact identifier, or other. When the obtaining unit 402 determines that the unlock command input by the user performing an operation on the target contact identifier in the set of the contact identifiers matches the preset unlock command, the unlocking unit 404 unlocks the terminal. If there is no match, the terminal keeps displaying the terminal unlock interface, and the obtaining unit 402 obtains the unlock command input by the user performing an operation on the target contact identifier in the set of the contact identifiers. Optionally, if there is no match, the determining unit 403 returns an information for indicating that the input unlock command is fault, and the displaying unit 401 displays the information on the terminal unlock interface. For example, if the command input by long press of the target contact identifier is the preset unlock command, when the unlock command obtained by the terminal is input by clicking the target contact identifier twice, the determining unit 403 of the terminal displays a text message recording information of performing a long press on the contact person for unlock on the terminal unlock interface.

Accordingly, the terminal further includes the following unit.

A receiving unit 406 is configured to receive the information for indicating that the input unlock command is fault from the determining unit 403 when the determining unit 403 determines that the unlock command does not match the preset unlock command.

Specifically, when the determining unit 403 determines that the unlock command does not match the preset unlock command, the determining unit 403 transmits the information for indicating that the input unlock command is fault to the receiving unit 406, and the displaying unit 401 displays the information on the display screen of the terminal. For example, if the command input by long press of the target contact identifier is the preset unlock command, when the unlock command obtained by the terminal is input by clicking the target contact identifier twice, the determining unit 403 transmits a text message recording information of performing a long press on the contact person for unlock to the receiving unit 406, and the receiving unit 406 transmits the information to the displaying unit 401 so as to display the information on the display screen of the terminal.

In the embodiments of the present invention, by presetting the contact person for unlock and the contact persons for interference in the terminal, by displaying the set of the contact identifiers including the contact identifiers of the contact person for unlock and the contact persons for interference on the terminal unlock interface, by obtaining the unlock command input by a user performing an operation on the target contact identifier in the set of the contact identifiers, and by unlocking the terminal when it is determined that the target contact identifier is the contact identifier for unlock and when it is determined that the input unlock command matches the preset unlock command, the protection for private data of the terminal brought by locking the terminal is enhanced, and the security and safety brought by locking the terminal is enhanced.

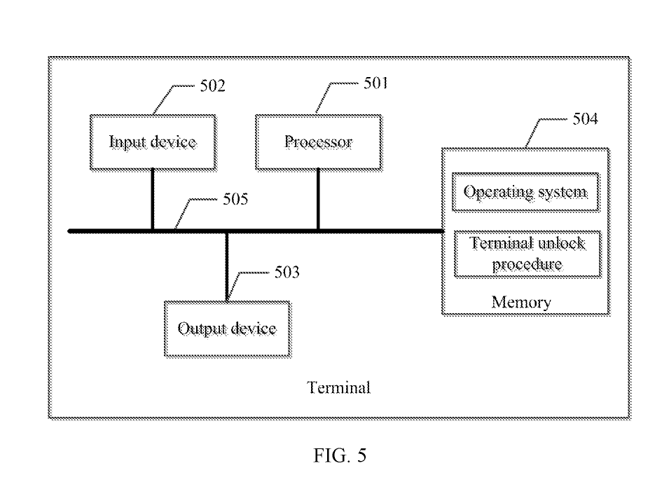

FIG. 5 is a schematic view of another structure of a terminal provided by an embodiment of the present invention. The terminal in the embodiment of this figure may include at least one processor 501 (e.g., CPU), at least one input device 502, at least one output device 503, and a memory 504. The processor 501, the input device 502, the output device 503, and the memory 504 are connected together via buses 505.

Wherein, the input device 502 may include a touch panel, a fingerprint sensor (used for collecting user's fingerprint information and direction information of the fingerprint), and so on. The input device 503 may include a display screen. The memory 504 may be a high-speed RAM, or a non-volatile memory, for example, at least one disk memory. The processor 501 can be illustrated in conjunction with the terminal shown in FIG. 4. Wherein the memory 504 stores a plurality of program codes, and the processor 501 invokes the programs codes stored in the memory 504 to execute the following operations.

The output device 403 is configured to display a set of contact identifiers on a terminal unlock interface. The set of the contact identifiers include a preset contact identifier for unlock and preset contact identifiers for interference.

The input device 502 is configured to obtain an unlock command input by the user performing an operation on a target contact identifier in the set of the contact identifiers.

The processor 501 is configured to determine whether or not the target contact identifier is the preset contact identifier for unlock.

The processor 501 is further configured to unlock the terminal when it is determined that the target contact identifier is the preset contact identifier for unlock.

In some possible embodiments, the processor 501 is further configured to execute the following operations.

An operation is to determine contact persons corresponding to communication events which have already been processed within a preset time period as the set of contact persons for unlock, or determine at least one contact person selected from a contact list by the user as the set of contact persons for unlock.

An operation is to select one contact person from the set of the contact persons for unlock as the contact person for unlock.

An operation is to select at least one contact person who is in a contact list of the user and outside of the set of the contact persons for unlock as the contact person for interference.

An operation is to obtain the contact identifiers of the contact person for unlock and the contact persons for interference to establish the set of the contact person identifiers.

The contact identifiers include at least one of contact names, contact nicknames, and contact head portraits.

The communication events which have already been processed include various communications events which at least have been looked up by the user to have an impression, such as read emails, read short messages, received calls or dialed calls, responses for chat, and so on.

The contact lists include at least one of various instant communication contact lists and various social software contact lists, such as an address book, an email contact list, a Wechat contact list, a QQ contact list, a Fetion contact list, a Renren friend list, and so on.

In some possible embodiments, the processor 501 is further configured to invoke the program codes stored in the memory 504 to execute the following operations when it is determined that the target contact identifier is not the contact identifier for unlock.

An operation is to select another contact person in the set of the contact persons for unlock as the contact person for unlock.

An operation is to select at least one other contact person who is in a contact list of the user and outside of the set of the contact persons for unlock as the contact person for interference.

An operation is to establish another set of the contact identifiers according to the contact identifiers of the another contact person for unlock and the at least one other contact person for interference.

An operation is to display the set of the another contact identifiers on the terminal unlock interface.

In some possible embodiments, the processor 501 is further configured to determine whether or not the unlock command matches the preset unlock command before unlocking the terminal. If it is determined that the unlock command input by the user does not match the preset unlock command, the processor 501 returns an information for indicating that the unlock command is fault, and displays the information via the output device 503.

Specifically, the processor 501, the input device 502, and the output device 504 described in the embodiments of the present invention can execute the implementation manners illustrated in the first embodiment and the second embodiment of the method for unlocking the terminal provided by the embodiments of the present invention, and can execute the implementation manners of the terminal illustrated in the embodiments of the present invention, which will not be repeated herein.

The units or sub-units in all embodiments of the present invention can be realized by a universal integrated circuit, such as a CPU (Central Processing unit, CPU) for example, or by an ASIC (Application Specific Integrated Circuit, ASIC).

According to actual need, the order of the steps of the methods in the embodiments of the present invention can be adjusted, some steps can be merged into one step, and some step can be deleted.

According to actual need, some units of the terminal in the embodiments of the present invention can be merged into one unit, some unit can be divided into several units, and some unit can be deleted.

One of ordinary skill in the art can understand that all or part of process can be accomplished by using a computer program to instruct related hardware. All the program can be stored in a computer-readable storage medium. When the program is executed, the process of the embodiments of the above-mentioned methods can be included. Wherein, the storage medium can be a magnetic disk, an optical disk, a ROM (Read-Only Memory, ROM), a RAM (Random Access Memory, RAM), or the like.

The embodiments of the present invention can display the set of the contact identifiers on the terminal unlock interface, obtain the unlock command input by the user performing an operation on the target contact identifier in the set of the contact identifiers, and unlock the terminal when it is determined that the target contact identifier is the contact identifier for unlock, thus the protection for private data of the terminal brought by locking the terminal is enhanced, and the security and safety brought by locking the terminal is enhanced.

The above specifically illustrates the method for unlocking the terminal and the terminal provided by the embodiments of the present invention. The embodiments described above are merely preferred ones of the present disclosure but are not limitations to the protection scope of the present disclosure, thus equivalent variations made according to the appended claims of the present invention still fall within the scope of the present invention.

What is claimed is:

1. A method for unlocking a terminal, comprising:
displaying a set of contact identifiers on a terminal unlock interface, wherein the set of the contact identifiers comprise a preset contact identifier for unlock and preset contact identifiers for interference;
obtaining an unlock command input by a user performing an operation on a target contact identifier in the set of the contact identifiers;
determining whether or not the target contact identifier is the preset contact identifier for unlock;
unlocking the terminal if yes.

2. The method of claim 1, wherein before displaying the set of contact identifiers on a terminal unlock interface, the method further comprises:
determining contact persons corresponding to communication events which have already been processed within a preset time period as the set of contact persons for unlock, or determining at least one contact person selected from a contact list by the user as the set of the contact persons for unlock;
selecting one contact person from the set of the contact persons for unlock as the contact person for unlock;
selecting at least one contact person who is in a contact list of the user and outside of the set of the contact persons for unlock as the contact person for interference;
obtaining the contact identifiers of the selected contact person for unlock and the at least one contact person for interference to establish the set of the contact identifiers.

3. The method of claim 2, wherein the step of selecting one contact person from the set of the contact persons for unlock as the contact person for unlock comprises selecting one contact person from the set of the contact persons for unlock as the contact person for unlock according to the happening time of communication events, determining one contact person selected from the set of the contact persons for unlock by the user as the contact person for unlock, or selecting one contact person from the set of the contact persons for unlock as the contact person for unlock randomly.

4. The method of claim 2, wherein when it is determined that the target contact identifier is not the preset contact identifier for unlock, the method further comprises:
selecting another contact person in the set of the contact persons for unlock as the contact person for unlock;
selecting at least one other contact person who is in a contact list of the user and outside of the set of the contact persons for unlock as the contact person for interference;
obtaining the contact identifiers of the another contact person for unlock and the at least one other contact person for interference to establish another set of the contact identifiers;
displaying the another set of the contact identifiers on the terminal unlock interface.

5. The method of claim 2, wherein the method further comprises:
displaying a prompt information for the selected contact person for unlock on the terminal unlock interface, wherein the prompt information comprises type information of processed communication events corresponding to the selected contact person for unlock.

6. The method of claim 1, wherein before unlocking the terminal, the method further comprises determining whether or not the unlock command input by the user matches a preset unlock command.

7. The method of claim 6, wherein an information for indicating that the unlock command is fault is returned if the unlock command input by the user does not match the preset unlock command.

8. A terminal comprising:
a displaying unit configured to display a set of contact identifiers on a terminal unlock interface, wherein the set of the contact identifiers comprise a preset contact identifier for unlock and preset contact identifiers for interference;
an obtaining unit configured to obtain an unlock command input by a user performing an operation on a target contact identifier in the set of the contact identifiers;
a determining unit configured to determine whether or not the target contact identifier is the preset contact identifier for unlock; and
an unlocking unit configured to unlock the terminal when it is determined that the target contact identifier is the preset contact identifier for unlock.

9. The terminal of claim 8, wherein the obtaining unit is further configured to determine contact persons corresponding to communication events which have already been processed within a preset time period as the set of contact persons for unlock, or determine at least one contact person selected from a contact list by the user as the set of the contact persons for unlock; the terminal further comprises a selecting unit configured to select one contact person from the set of the contact persons for unlock as the contact person for unlock; the selecting unit is further configured to select at least one contact person who is in a contact list of the user and outside of the set of the contact persons for unlock as the contact person for interference; the obtaining unit is further configured to obtain the contact identifiers of the selected contact person for unlock and the contact persons for interference to establish the set of the contact person identifiers.

10. The terminal of claim 9, wherein the selecting unit being configured to select one contact person from the set of the contact persons for unlock as the contact person for unlock comprises selecting one contact person from the set of the contact persons for unlock as the contact person for unlock according to the happening time of communication events, determining one contact person selected from the set of the contact persons for unlock by the user as the contact person for unlock, or selecting one contact person from the set of the contact persons for unlock as the contact person for unlock randomly.

11. The terminal of claim 9, wherein the selecting unit is further configured to select another contact person in the set of the contact persons for unlock as the contact person for unlock; the selecting unit is further configured to select at least one other contact person who is in a contact list of the user and outside of the set of the contact persons for unlock as the contact person for interference; the obtaining unit is further configured to obtain the contact identifiers of the another contact person for unlock and the at least one other contact person for interference to establish another set of the contact identifiers; the displaying unit is further configured to display the another set of the contact identifiers on the terminal unlock interface.

12. The terminal of claim 9, wherein the displaying unit is further configured to display a prompt information for the selected contact person for unlock on the terminal unlock interface, wherein the prompt information comprises type information of processed communication events corresponding to the selected contact person for unlock.

13. The terminal of claim 8, wherein the determining unit is further configured to determine whether or not the unlock command input by the user matches a preset unlock command before unlocking the terminal.

14. The terminal of claim 13, wherein the terminal further comprises a receiving unit configured to receive an information for indicating that the unlock command is fault from the determining unit when the determining unit determines that the unlock command input by the user does not match the preset unlock command.

15. A terminal comprising:
a memory storing a plurality of program codes; and
a processor electrically connected to the memory and configured to execute the plurality of program codes to:
display a set of contact identifiers on a terminal unlock interface, wherein the set of the contact identifiers comprise a preset contact identifier for unlock and preset contact identifiers for interference;
obtain an unlock command input by a user performing an operation on a target contact identifier in the set of the contact identifiers;
determine whether or not the target contact identifier is the preset contact identifier for unlock; and
unlock the terminal when it is determined that the target contact identifier is the preset contact identifier for unlock.

16. The terminal of claim 15, wherein the processor is further configured to execute the plurality of program codes to determine contact persons corresponding to communication events which have already been processed within a preset time period as the set of contact persons for unlock, or determine at least one contact person selected from a contact list by the user as the set of the contact persons for unlock; the processor is further configured to execute the plurality of program codes to select one contact person from the set of the contact persons for unlock as the contact person for unlock, select at least one contact person who is in a contact list of the user and outside of the set of the contact persons for unlock as the contact person for interference, and obtain the contact identifiers of the selected contact person for unlock and the contact persons for interference to establish the set of the contact person identifiers.

17. The terminal of claim 16, wherein the processor being configured to execute the plurality of codes to select one contact person from the set of the contact persons for unlock as the contact person for unlock comprises selecting one contact person from the set of the contact persons for unlock as the contact person for unlock according to the happening time of communication events, determining one contact person selected from the set of the contact persons for unlock by the user as the contact person for unlock, or selecting one contact person from the set of the contact persons for unlock as the contact person for unlock randomly.

18. The terminal of claim 16, wherein the processor is further configured to execute the plurality of codes to select another contact person in the set of the contact persons for unlock as the contact person for unlock, select at least one other contact person who is in a contact list of the user and outside of the set of the contact persons for unlock as the contact person for interference, obtain the contact identifiers of the another contact person for unlock and the at least one other contact person for interference to establish another set of the contact identifiers, and display the another set of the contact identifiers on the terminal unlock interface.

19. The terminal of claim 16, wherein the processor is further configured to execute the plurality of program codes to display a prompt information for the contact person for unlock on the terminal unlock interface, wherein the prompt information comprises type information of processed communication events corresponding to the contact person for unlock.

20. The terminal of claim 15, wherein the processor is further configured to execute the plurality of program codes to determine whether or not the unlock command input by the user matches a preset unlock command before unlocking the terminal.

21. The terminal of claim 20, wherein the processor is further configured to execute the plurality of program codes to receive an information for indicating that the unlock command is fault when it is determined that the unlock command input by the user does not match the preset unlock command.
